(19) United States
(12) Patent Application Publication
(10) Pub. No.: US 2026/0014653 A1
(43) Pub. Date: Jan. 15, 2026

(54) METHOD OF WELDING A STEEL SHEET COMPRISING TIB2 PRECIPITATES

(71) Applicant: ArcelorMittal, Luxembourg (LU)

(72) Inventors: Jessy HAOUAS, Saint Ail (FR); Frederic BONNET, Avril (FR); Valerie DAESCHLER, Roncourt (FR)

(21) Appl. No.: 18/880,898

(22) PCT Filed: Jul. 19, 2022
(86) PCT No.: PCT/IB2022/056626

§ 371 Date: Jan. 3, 2025

(51) Int. Cl. B23K 35/30; B23K 9/025; B23K 9/16; B23K 35/38; B23K 101/00; B23K 103/04; C22C 38/00; C22C 38/02; C22C 38/04; C22C 38/06; C22C 38/14

(52) U.S. Cl. CPC B23K 35/3073; B23K 9/025; B23K 9/16; B23K 35/3093; B23K 35/383; C22C 38/002; C22C 38/02; C22C 38/04; C22C 38/06; C22C 38/14; B23K 2101/006; B23K 2103/04

(57) ABSTRACT

A process for welding at least two steel sheets including the following successive steps: providing at least one steel sheet having a composition including the following elements, expressed by weight percent: 0.01%≤C≤0.2%, 2.5%≤Ti≤10%, (0.45×Ti)−1.35%≤B≤(0.45×Ti)+0.70%, S≤0.03%, P≤0.04%, N≤0.05%, O≤0.05% and including precipitates of TiB₂, the balance being Fe and unavoidable impurities resulting from the elaboration, providing a second steel sheet, welding the first steel sheet and the second steel sheet by using a filler wire, the filler wire having a composition, including Ti: 0.8-2 wt % to obtain a molten zone having an average content of free titanium Ti* above or equal to 0.60 wt %.

The present invention relates to a method for welding a steel sheet comprising precipitates of TiB₂ with at least one second steel sheet.

### BACKGROUND

Steel sheets comprising precipitates of TiB₂ (herein after TiB₂ steel sheet) have been attracting much attention due to their excellent high elastic modulus, low density and high tensile strength. However, such sheets can be difficult to weld, in particular the stresses during the cooling of the weld bead can lead to the propagation of intergranular cracks along the grain boundaries in the molten zone.

### SUMMARY OF THE INVENTION

It is an object of the present invention to provide a method to weld TiB₂ steel sheets with at least one second sheet, without formation of cracks in the molten zone.

The present invention provides a process for welding at least two steel sheets comprising the following successive steps:
providing at least a first steel sheet having a composition comprising the following elements, expressed by weight percent:

$$\begin{matrix}0.01 \% \leq C \leq 0.2 \% \\ 2.5 \% \leq Ti \leq 10 \% \\ ( 0.45 \times Ti ) - 1.35 \% \leq B \leq ( 0.45 \times Ti ) + 0.7 \% \\ S \leq 0.03 \% \\ P \leq 0.04 \% \\ N \leq 0.05 \% \\ O \leq 0.05 \% \\ and optionally containing : \\ Si \leq 1.5 \% \\ Mn \leq 3 \% \\ Al \leq 1.5 \% \\ Ni \leq 1 \% \\ Mo \leq 1 \% \\ Cr \leq 3 \% \\ Cu \leq 1 \% \\ Nb \leq 0.1 \% \\ V \leq 0.5 \%\end{matrix}$$

and comprising precipitates of TiB₂, the balance being iron and unavoidable impurities resulting from the elaboration
   providing a second steel sheet,
welding the first steel sheet and the second steel sheet by using a filler wire with a shielding gas, said filler wire comprising the following elements, expressed by weight percent:

$$\begin{matrix}Ti : 0.8 - 2 \% \\ C : 0.02 \% - 0.25 \% \\ Mn : 0.5 \% - 3.5 \% \\ Si : 0.2 - 2. \% \\ Al \leq 0.5 \% \\ P \leq 0. 020 \% \\ S \leq 0. 020 \% \\ N \leq 0. 050 \%\end{matrix}$$

the balance being iron and unavoidable impurities resulting from the elaboration, the titanium content of such filler wire being selected so as to obtain a molten zone having an average content of free titanium Ti* above or equal to 0.60 wt %.

The present invention also provides a welded joint of at least two steel sheets obtained by the process described, wherein the welded joint comprises a molten zone comprising an average free titanium above or equal to 0.60 wt %.

### BRIEF DESCRIPTION OF THE DRAWINGS

The present invention will now be described in detail and illustrated by examples without introducing limitations, with reference to the appended figures:

FIG. 1 illustrates a schematic view of the lap joint welding,

FIG. 2 represents the section of the lap joint welding of trial 11, which is not according to the present invention,

FIG. 3 represents a micrograph of the molten zone and the points used to calculate the average content of free titanium Ti*,

FIG. 4 represents a micrograph of trial 2, which is according to the present invention,

FIG. 5 represents a micrograph obtained by SEM of trial 10, which is not according to the present invention, and

FIG. 6 represents a micrograph obtained by confocal microscopy of trial 10, which is not according to the present invention.

### DETAILED DESCRIPTION

Without willing to be bound by any theory, it seems that the welding method according to the present invention performed on a TiB₂ steel sheet with a second steel sheet allows avoiding formation of cracks in the molten zone.

The present invention relates to a welding method of at least two steel sheets comprising the following successive steps:
providing at least a first steel sheet having a composition comprising the following elements, expressed by weight percent:

$$\begin{matrix}0.01 \% \leq C \leq 0.2 \% \\ 2.5 \% \leq Ti \leq 10 \% \\ ( 0.45 \times Ti ) - 1.35 \% \leq B \leq ( 0.45 \times Ti ) + 0.7 \% \\ S \leq 0.03 \% \\ P \leq 0.04 \% \\ N \leq 0.05 \% \\ O \leq 0.05 \% \\ and optionally containing : \\ Si \leq 1.5 \% \\ Mn \leq 3 \% \\ Al \leq 1.5 \% \\ Ni \leq 1 \% \\ Mo \leq 1 \% \\ Cr \leq 3 \% \\ Cu \leq 1 \% \\ Nb \leq 0.1 \% \\ V \leq 0.5 \%\end{matrix}$$

and comprising precipitates of TiB₂, the balance being Fe and unavoidable impurities resulting from the elaboration, hereinafter TiB₂ steel sheet,
providing a second steel sheet,
welding the TiB₂ steel sheet and the second steel sheet by using a filler wire having a chemical composition expressed in weight percent, comprising titanium content Ti from 0.8 to 2%.

The composition of the filler wire according to the present invention will now be described, the content being expressed in weight percent (wt. %).

According to the present invention the titanium content of the filler wire comprises from 0.8% to 2% to ensure an average free titanium Ti* in the molten zone above or equal to 0.60%. Free titanium Ti* is titanium that is not trapped as a precipitate or inclusion.

During welding of the TiB₂ sheet with a second steel sheet, the average content of free titanium in the molten zone usually depends on:
the chemical composition of the sheets,
the chemical composition of the filler wire,
the atmosphere.

A first effect of the chemical composition of the sheets and of the filler wire on the amount of free titanium in the molten zone is the dilution. Dilution is a phenomenon that occurs between the two welded sheets with the filler wire. Considering only the dilution phenomenon, the titanium content of the molten zone would depend on the contribution of titanium by each of the sheets in the molten zone, as well as the contribution of titanium by the welding wire.

A second effect of the chemical composition of the sheets and of the filler wire on the amount of free titanium in the molten zone is the formation of precipitates or inclusions. The carbon present in the welded sheet and in the filler wire can react with the titanium forming TiC precipitates and/or Ti(C_{y}N_{1-y}) in the molten zone.

The same is true for the nitrogen present in the sheets and the filler wire, which can form TiN. But most of the TiN formed comes from the reaction of titanium with the atmosphere, due to poor gas protection during welding. The solubility of nitrogen being very low in liquid metal, the contact of this liquid metal with the atmosphere creates TiN.

Titanium also reacts with oxygen from the atmosphere and/or the gas shielding to form TiOₓ (TiO, TiO₂, Ti₂O₃).

All these phenomena then reduce the quantity of free titanium in the molten zone, which limit the boron protection and thus promote the precipitation of intergranular Fe—TiB₂—Fe₂B eutectic phase (hereinafter Fe₂B). These Fe₂B precipitates are brittle and can generate the formation of intergranular cracks during the cooling of the bead.

By having a titanium content above or equal to 0.8 wt. %, the filler wire is dimensioned in such a way as to counterbalance the above effects if the welding is performed under a shielding gas like, for example, argon possibly comprising up to 20 v. % of CO₂, preferably up to 18 v. % of CO₂. The addition of more of 2 wt % of titanium would be costly and ineffective in view of the properties which are required.

The titanium content of the filler wire can be determined by depositing between two metal sheets the wire metal in several layers, for example seven layers, so that there is no dilution effect between the metal sheets and the metal wire, under a protective gas, which can consist of 82 v. % of argon and 18 v. % of CO₂, and by measuring the titanium content in the deposited metal.

The rest of the composition of the filler wire mainly depends on the expected mechanical properties of the molten zone. In addition to titanium, the filler wire comprises (in weight percent wt. %):

$$\begin{matrix}C 0.02 \% - 0.25 \% \\ Mn : 0.5 \% - 3.5 \% \\ Si 0.2 - 2 \% \\ Al \leq 0.5 \%\end{matrix}$$

The remainder of the composition of the wire is iron and impurities. In this respect, P, S and N at least are considered as residual elements which are unavoidable impurities. Their content is below or equal to 0.020% for S, below or equal to 0.020% for P and below or equal to 0.050% for N.

In a preferred embodiment of the present invention, the second steel sheet can be a multiphase steel as a dual-phase (DP) steel, a complex phase (CP) steel, a ferrito-bainitic (FB) steel, a TRIP steel, a martensitic steel, a TRIPLEX stee, a TWIP steel, IF steel, high strength low alloy (HSLA) steel or aluminium killed steel.

In an other preferred embodiment of the present invention, the second steel sheet is a TiB₂ steel sheet.

Preferably, the total titanium content % Tiₜₒₜₐₗ in the molten zone resulting from the mixture of the TiB₂ steel sheet, the second steel sheet and the wire satisfy the following equation:

$$\% {Ti}_{total} \geq \% {B}_{t otal} * ( 47.867 / 2 * 10.811 ) + ( 47. 8 \; 67 / 14 ) * \% {N}_{total} + ( 47. 8 \; 67 / 16 * x ) * \% {O}_{total} + ( 47.867 / ( 12 * y ) ) * \% {C}_{total}$$

wherein % Bₜₒₜₐₗ, % Nₜₒₜₐₗ, % Oₜₒₜₐₗ, % Cₜₒₜₐₗ are the total boron, nitrogen, oxygen and carbon contents in the molten zone and x and y are the stochiometric coefficients related respectively to the precipitation of TiOₓ and Ti(C_{y}N_{1-y}), x being equal to 1, 2 or 3/2, y varying between 0 and 1.

Such total titanium content includes both the free titanium and the titanium trapped in various precipitates (oxides, carbides, nitrides, carbo-nitrides).

The welding method used to weld the TiB₂ steel sheet with the second steel sheet can be any arc welding such as MAG welding, TIG welding, MIG welding, plasma welding or laser welding using a shielding gas.

Preferably, the shielding gas is argon. The shielding gas can comprise CO₂.

Process welding without the use of shielding gas, as submerged arc welding can be envisaged, with a risk of oxidation of titanium.

According to the present invention, the welded joint between the TiB₂ steel sheet and at least one steel sheet, comprises a molten zone having an average free titanium above or equal to 0.60%, in order to obtain a molten zone without cracks.

The present invention will be now illustrated by the following example, which are by no way limitative.

### Examples

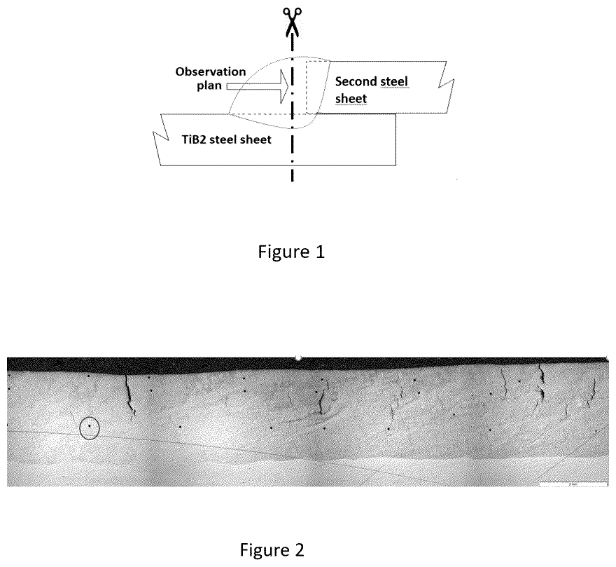

A TiB₂ steel sheet is joined to a second steel sheet (FB or DP) by an overlap welding technic. The TiB₂ steel sheet is the bottom sheet, the second steel sheet is the upper sheet, as schematically illustrated on FIG. 1. Two thicknesses of TiB₂ sheets are used. The chemical composition of the sheets (expressed in weigh percent wt. %) and their thicknesses (expressed in mm) are given in Table 1.

TABLE 1
Steel sheets chemical composition

| | | | | | | | | | | | | | | | Thickness |
|---|---|---|---|---|---|---|---|---|---|---|---|---|---|---|---|
| Steel | | Ti | B | C | Mn | Si | Cr | Al | P | S | N | O | Ni | Cu | (mm) |
| Bottom | TiB₂ | 5.32 | 1.67 | 0.02 | 0.06 | 0.17 | 0.12 | 0.039 | 0.008 | 0.007 | 0.001 | 0.0018 | 0.022 | 0.023 | 1.4 |
| sheet | 1.4 | | | | | | | | | | | | | | |
| | TiB₂ | 5.32 | 1.67 | 0.02 | 0.06 | 0.17 | 0.12 | 0.039 | 0.008 | 0.007 | 0.001 | 0.0018 | 0.022 | 0.023 | 2.5 |
| | 2.5 | | | | | | | | | | | | | | |
| Upper | FB | 0.002 | — | 0.08 | 1.52 | 0.08 | — | — | 0.023 | 0.004 | 0.007 | — | — | — | 2.7 |
| sheet | DP | 0.002 | — | 0.07 | 1.55 | 0.3 | — | — | 0.014 | 0.003 | | — | — | — | 1.8 |

Filler wires having a diameter of 1 mm, are used to weld the steel sheets together. The chemical composition of these wires is determined before the welding of the two steel sheets, by depositing the metal wire between two sheets in seven layers, so that there is no dilution effect between the sheets and the metal wire, under a protective gas consisting of 82 v. % of argon and 18 v. % of CO₂, and by measuring the content of elements in the deposited metal. These chemical compositions are given in Table 2.

TABLE 2
Wires chemical composition

| Wire | | | | | | | | |
|---|---|---|---|---|---|---|---|---|
| composition | | | | | | | | |
| (wt. %) | Ti | C | Mn | Si | Al | P | S | N |
| A | 0.94 | 0.08 | 1.70 | 0.90 | 0.160 | 0.010 | 0.010 | 0.007 |
| B | 1.11 | 0.09 | 1.70 | 0.90 | 0.180 | 0.010 | 0.010 | 0.008 |
| C | 1.05 | 0.09 | 1.70 | 0.30 | 0.150 | 0.009 | 0.010 | 0.008 |
| D | 1.31 | 0.07 | 1.70 | 0.90 | 0.170 | 0.010 | 0.010 | 0.004 |
| E | 0.01 | 0.07 | 1.73 | 0.95 | 0.001 | 0.015 | 0.017 | — |
| F | — | 0.08 | 7.00 | 0.80 | — | 0.015 | 0.015 | — |

Underlined values: not corresponding to the present invention.

The wire compositions A-D are according to the present invention, the wire compositions E and F are reference examples with F having a titanium amount not corresponding to the present invention.

The upper and bottom sheets were welded together at a welding speed of 500 mm/min, by a MAG or MIG process under a shielding gas. The welding parameters are given in Table 3.

TABLE 3
Welding process parameters

| | Upper | Bottom | | Welding | | Amperage | Voltage |
|---|---|---|---|---|---|---|---|
| Trials | Sheet | sheet | Wire | process | Shielding gas | (A) | (V) |
| 1 | DP | TiB₂ 1.4 | A | MIG | Ar | 155 | 16.1 |
| 2 | DP | TiB₂ 1.4 | B | MIG | Ar | 148 | 16.4 |
| 3 | FB | TiB₂ 2.5 | B | MIG | Ar | 204 | 16.9 |
| 4 | FB | TiB₂ 2.5 | B | MAG | Ar + 18% CO2 | 201 | 17.2 |
| 5 | FB | TiB₂ 2.5 | C | MIG | Ar | 209 | 16.8 |
| 6 | FB | TiB₂ 2.5 | D | MAG | Ar + 18% CO2 | 195 | 17.4 |
| 7 | DP | TiB₂ 1.4 | D | MIG | Ar | 159 | 16.0 |
| 8 | DP | TiB₂ 1.4 | B | MAG | Ar + 18% CO2 | 150 | 16.1 |
| 9 | DP | TiB₂ 1.4 | A | MAG | Ar + 18% CO2 | 148 | 16.4 |
| 10 | FB | TiB₂ 2.5 | E | MAG | Ar + 8% CO2 | 161 | 23.2 |
| 11 | FB | TiB₂ 2.5 | E | MAG | Ar + trailing | 175 | 22.2 |
| | | | | | shield | | |
| 12 | FB | TiB₂ 2.5 | F | MIG | Ar + 2% CO2 | 186 | 20.7 |

Underlined values: not corresponding to the present invention.

The molten zone obtained after welding the two steel sheets is observed in the direction of the upper sheet, as shown schematically in FIG. 1. A specimen is cut around the molten zone in order to obtain a section comprising both steel sheets and the molten zone, polished and etched with a reagent known per se, for example Nital reagent. This section is then observed by Scanning Electron Microscopy (SEM) and can be coupled with an Energy Dispersive X-Ray analysis (SEM-EDX).

In the resulting micrograph of the molten zone, 21 markers are chosen to cover all of the section of the molten zone, as represented by black dots in FIG. 2, corresponding to a magnification ×2.5.

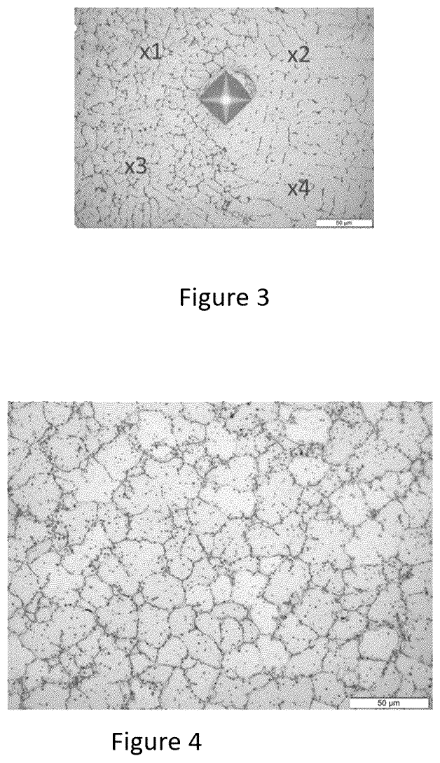

The free titanium is then measured by EDX at 4 points around these markers, as represented in FIG. 3 (with a magnification ×50) by x1, x2, x3 and x4, which make it possible to obtain 21*4=84 measures of free titanium in the molten zone.

The average free titanium content Ti* calculated by an average of these 84 measures, the minimum value of free titanium content measured Ti min and the maximum value of free titanium content Ti*ₘₐₓ measured in the molten zone, all expressed in weight percent wt %, are given in Table 4.

In addition, the presence of Fe₂B precipitates is given in Table 4.

TABLE 4
Free titanium content and cracks

| | Ti* | Ti*ₘᵢₙ | Ti*ₘₐₓ | Cracks in the | |
|---|---|---|---|---|---|
| Trials | (wt. %) | (wt. %) | (wt. %) | molten zone | Fe₂B |
| 1 | 0.97 | 0.74 | 1.25 | No | No |
| 2 | 0.91 | 0.69 | 1.31 | No | No |
| 3 | 0.79 | 0.61 | 1.07 | No | No |
| 4 | 0.65 | 0.50 | 0.93 | No | No |
| 5 | 0.82 | 0.63 | 1.18 | No | No |
| 6 | 0.77 | 0.61 | 1.01 | No | No |
| 7 | 0.97 | 0.70 | 1.32 | No | No |
| 8 | 0.60 | 0.31 | 0.79 | No | Yes |
| 9 | 0.54 | 0.31 | 0.78 | Yes | Yes |
| 10 | 0.47 | 0.23 | 0.68 | Yes | Yes |
| 11 | 0.36 | 0.20 | 0.57 | Yes | Yes |
| 12 | nd | nd | nd | Yes | Yes |

Underlined values: not corresponding to the present invention
nd: non-determined value

Thanks to the specific composition of the filler wire and process parameters used, the examples according to the present invention, namely examples 1-8 shown that no crack appear in the molten zone, when the average free titanium content Ti* is above or equal to 0.60 wt. %. FIG. 4 represents the micrograph obtained by SEM for the trial 2, in which no crack in the molten zone, and no Fe₂B precipitate are presents.

In trial 8, a few Fe₂B precipitates were observed in the bead.

In comparison to Trial 2, where the sheet is welded under a shielding gas consisting of argon only, the same sheet in Trial 8 is welded with a wire of the same composition, but under a shielding gas also including CO₂. The free titanium is then reduced compared to Trial 2, as the titanium has reacted with the oxygen present.

This lower value of average free titanium content then allows some Fe₂B precipitates to form but is still sufficient to avoid the formation and propagation of cracks in the molten zone.

In trial 9, the two sheets are welded under a shielding gas consisting of 82 v. % argon and 18 v. % CO₂, compared to trial 1, in which the same sheets are welded together, with the same wire, but under a shielding gas consisting only of argon.

The free titanium is then reduced compared to Trial 1, as the titanium has reacted with the oxygen present, creating titanium oxides.

This low value of average free titanium content then allows Fe₂B precipitates to form and is not sufficient to avoid the formation and propagation of cracks in the molten zone.

The sheets of trials 10 and 11 were welded by a filler wire containing 0.01 wt. % of titanium, and the sheets of trial 12 were welded with a filler wire containing no titanium. This results in an average free titanium content Ti* of less than 0.60 wt % in the molten zone, which favors the formation of brittle Fe₂B precipitates, and the formation and propagation of cracks.

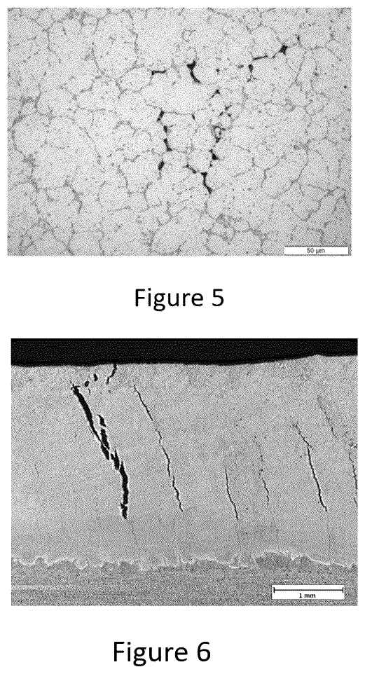

FIG. 6 represents a longitudinal section of the molten zone of trial 10, obtained by confocal microscopy, on which cracks are observed. Fe₂B precipitates are visible in the micrograph obtained by SEM shown in FIG. 5.

The sheets of trial 11 were welded by a filler wire with a too small content of titanium, under a shielding gas of argon coupled to a trailing shield. Despite this device providing high quality gas coverage, the average free titanium content in the molten zone remains too low to avoid the formation of Fe₂B precipitates and cracks in the molten zone.

What is claimed is:

1-6. (canceled)

7. A process for welding at least two steel sheets comprising the following successive steps:
providing at least a first steel sheet having a composition comprising the following elements, expressed by weight percent:
$$\begin{matrix}0.01 \% \leq C \leq 0.2 \% ; \\ 2.5 \% \leq Ti \leq 10 \% ; \\ ( 0.45 \times Ti ) - 1.35 \% \leq B \leq ( 0.45 \times Ti ) + 0.7 \% ; \\ S \leq 0.03 \% ; \\ P \leq 0.04 \% ; \\ N \leq 0.05 \% ; \\ O \leq 0.05 \% ; \\ and optionally containing : \\ Si \leq 1.5 \% ; \\ Mn \leq 3 \% ; \\ Al \leq 1.5 \% ; \\ Ni \leq 1 \% ; \\ Mo \leq 1 \% ; \\ Cr \leq 3 \% ; \\ Cu \leq 1 \% ; \\ Nb \leq 0.1 \% ; \\ V \leq 0.5 \% ;\end{matrix}$$
and
comprising precipitates of TiB₂, a balance being iron and unavoidable impurities resulting from the elaboration;
providing a second steel sheet;
welding the first steel sheet and the second steel sheet by using a filler wire with a shielding gas, the filler wire comprising the following elements, expressed by weight percent:
$$\begin{matrix}Ti : 0.8 - 2 \% ; \\ C : 0.02 \% - 0.25 \% ; \\ Mn : 0.5 \% - 3.5 \% ; \\ Si : 0.2 - 2. \% ; \\ Al \leq 0.5 \% ; \\ P \leq 0.02 \% ; \\ S \leq 0.02 \% ; \\ N \leq 0.05 \% ;\end{matrix}$$
a filler wire balance being iron and unavoidable impurities resulting from the elaboration, a titanium content of the filler wire being selected so as to obtain a molten zone having an average content of free titanium Ti* above or equal to 0.60 wt %.

8. The process for welding according to claim 7 wherein the second steel is a dual-phase (DP) steel, complex phase (CP) steel, a TRIP steel, a ferrito-bainitic (FB) steel, a martensitic steel, a TRIPLEX steel, a TWIP steel, an IF steel, a high strength low alloy steel, or an aluminium killed steel.

9. The process for welding according to claim 7 wherein the second steel sheet has a second composition including the following elements, expressed by weight percent:
$$\begin{matrix}0.01 \% \leq C \leq 0.2 \% ; \\ 2.5 \% \leq Ti \leq 10 \% ; \\ ( 0.45 \times Ti ) - 1.35 \% \leq B \leq ( 0.45 \times Ti ) + 0.7 \% ; \\ S \leq 0.03 \% ; \\ P \leq 0.04 \% ; \\ N \leq 0.05 \% ; \\ O \leq 0.05 \% ; \\ and optionally containing : \\ Si \leq 1.5 \% ; \\ Mn \leq 3 \% ; \\ Al \leq 1.5 \% ; \\ Ni \leq 1 \% ; \\ Mo \leq 1 \% ; \\ Cr \leq 3 \% ; \\ Cu \leq 1 \% ; \\ Nb \leq 0.1 \% ; \\ V \leq 0.5 \% ;\end{matrix}$$
and including precipitates of TiB₂, a second composition balance being Fe and unavoidable impurities resulting from the elaboration

10. The process for welding according to claim 7 wherein the welding is performed by at least one of the following: MAG welding, TIG welding, MIG welding, plasma welding and laser welding using a shielding gas.

11. The process for welding according to claim 10 wherein the welding uses the shielding gas and the shielding gas includes argon.

12. The process for welding as recited in claim 11 wherein the shielding gas includes 20 v. % of CO₂.

13. A welded joint obtained by the process as recited in claim 7, the welded joint comprising the molten zone.

14. A process for manufacturing an automotive vehicle comprising performing the process as recited in claim 7.
